(19) United States
(12) Patent Application Publication
(10) Pub. No.: US 2025/0014469 A1
(43) Pub. Date: Jan. 9, 2025

(54) ONLINE LEARNING PLATFORMS WITH ENHANCED PROMPT ASSIGNMENTS

(71) Applicant: Microsoft Technology Licensing, LLC, Redmond, WA (US)

(72) Inventors: Michael THOLFSEN, Newcastle, WA (US); Emma Margaret GRAY, Vancouver (CA); Ella BEN TOV, Tel Aviv (IL); Shay BEN-ELAZAR, Herzliya (IL)

(21) Appl. No.: 18/506,815

(22) Filed: Nov. 10, 2023

Related U.S. Application Data
(60) Provisional application No. 63/512,363, filed on Jul. 7, 2023.

(51) Int. Cl. G09B 5/02

(52) U.S. Cl. CPC G09B 5/02

(57) ABSTRACT

The technology disclosed herein includes a method of operating a learning platform that includes observing the prompt drafting activities of an observed user with respect to a prompt assignment, submitting a prompt to a foundation model via the learning platform, and displaying a reply from the foundation model in a user interface to learning platform. The technology disclosed herein further includes a method of surfacing, based on the prompting activities, an option suggesting a revision to a prompt constructed by an observed user via the user interface.

### CROSS-REFERENCE TO RELATED APPLICATIONS

This patent application claims priority to and the benefit of U.S. Provisional Patent Application No. 63/512,363 filed on Jul. 7, 2023, that is hereby incorporated by reference as if set forth in its entirety.

### TECHNICAL FIELD

Aspects of the disclosure are related to the field of computer software applications and services and, in particular, to online learning platforms and insights.

### BACKGROUND

Online learning platforms aim to simplify the process of creating, distributing, and grading homework assignments while facilitating seamless communication between reviewers and observed users. For example, these platforms enable reviewers to create assignments and share them with their classes. Observed users can then access and complete the assignments online and submit the assignments electronically through the platform. Reviewers can evaluate the completed assignments and provide feedback without leaving the platform. This streamlined workflow greatly benefits both observed users and reviewers, enhancing classroom efficiency.

Many classroom assignments require observed users to conduct research using online search engines. Recent advancements in online computing and communication technologies have introduced powerful artificial intelligence (AI) models into various online environments, including search engines. For example, users may interact with AI models through conversational prompts, which elicit responses from the AI models. The quality of a user's experience with an AI model is dependent upon many factors, not the least of which is the quality of the user's prompting. Prompting is the act of generating and submitting inputs or queries to an AI model to elicit a specific response from the AI model. The prompts themselves may be natural language statements or questions, code snippets, or the like.

While the speed and convenience provided by AI models are remarkable, many users struggle to use them effectively, including by submitting low-quality prompts. Poor prompt drafting skills impact observed users in both near-term assignment completion and long-term skill development, since the quality of their research suffers based on the poor responses elicited from the AI model. As AI-powered tools advance and become ubiquitous in the workplace and schools, users who lack proficiency with respect to prompting are at risk of falling behind in their careers and education. In addition, ineffective prompts can produce results that are too scattered or unfocused to be of much use to a user. Indeed, it is common for users to repeatedly redo their prompts in an effort to elicit better results, resulting in a waste of time on their part, and a waste of resources on a global scale with respect to the compute resources needed to perform the searches. Many AI models also enforce token limits on conversations, further driving the demand for prompting proficiency.

### SUMMARY

Technology disclosed herein includes software applications and services that provide an enhanced user experience with respect to online learning platforms in general, and prompt engineering instruction more particularly. In various implementations, prompt assignments (or any assignments having a prompt drafting component to them) direct users to draft prompts for submission to a foundation model, while an enhanced user experience allows users to access recommendations to amend the prompt prior to submitting the prompt to the foundation model. Such improvements allow users to be guided with respect to their prompt drafting skills, improving prompt drafting skills in general and conserving time and resources more broadly.

In an exemplary implementation, a method of operating an online learning platform includes observing, on a per-user basis with respect to each user in a group of observed users, the prompting associated with a foundation model service, identifying, on the per-user basis with respect to each of the group of observed users, insights into the prompting, and enabling display of the insights in a user interface associated with a reviewer. Options for amending the prompts may also be surfaced, based on the insights, in a user interface associated with a user of the group of observed users.

Observing the prompting includes observing prompts submitted to a foundation model service, observing replies to the prompts from the foundation model service, and observing user actions with respect to the prompts and/or replies. The method may also include observing changes made to the prompts before they are submitted to a foundation model service (e.g., after displaying a suggestion to edit the prompt). The method may also include observing differences between the context of an original prompt and subsequent prompts submitted to the foundation model service (e.g., prompts submitted after receiving a reply from the foundation model service). The method may further include classifying the prompts as being concise, unconcise, focused, unfocused, etc.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modification's, and equivalents.

FIG. 1 illustrates an operational environment in an implementation.

FIG. 2 illustrates a prompt assignment process in an implementation.

FIG. 3 illustrates an operational scenario in an implementation.

FIG. 4 illustrates an operational scenario in an implementation.

FIG. 5 illustrates an operational environment in an implementation.

FIGS. 6A-6F illustrate an observational-centric user experience in an implementation.

FIGS. 7A-7D illustrate a reviewer-centric user experience in an implementation.

FIG. 8 illustrates a computing system suitable for implementing the various operational environments, architectures, processes, scenarios, and sequences discussed below with respect to the other Figures.

### DETAILED DESCRIPTION

Technology disclosed herein is generally directed to an enhanced user experience with respect to online learning platforms that allows individual observed users (e.g., students, workforce personnel) as well as groups of learners to improve their prompt drafting techniques in a defined environment. In various implementations, a reviewer (e.g., a teacher, a reviewer, a manager, or other such personnel in reviewing positions) may configure a prompt assignment that asks observed users to draft a prompt for submission to a foundation model service. Via a classroom mode of a learning application, the observed users access a view of the prompt assignment and use a prompt assignment mode of a learning application to complete the assignment. The prompt assignment mode includes an indication of the assignment and a text field through which to draft a prompt associated with the assignment. An observed user may select a control in a user interface to transition the user interface from a classroom mode to a prompt assignment mode.

As the observed users draft and submit various prompts in association with the assignment, each version of the prompt is recorded and analyzed for potential feedback. The feedback may include suggestions for improving the prompt and may be surfaced in a user interface. An observed user may amend their prompt based on the feedback and submit either the original prompt or the amended prompt to elicit a response from a foundation model. Additional feedback may also be surfaced in a user interface after a prompt is submitted to the foundation model. The additional feedback may include suggestions for editing the original prompt based on the response provided by the foundation model.

Once the observed user is satisfied with the assignment, the observed user may turn the assignment in to the reviewer. The reviewer may access prompting trends (e.g., via a reviewer mode) that provide a holistic view of the prompting activities of the observed users. Providing access to the prompting insights allows the reviewer to coach an observed user (or allows the observed users themselves to learn) to engage the full capabilities of a foundation model more proficiently.

Foundation models include large-scale generative artificial intelligence (AI) models trained on massive quantities of diverse, unlabeled data using self-supervised, semi-supervised, or unsupervised learning techniques. Foundation models may be based on a number of different architectures, such as generative adversarial networks (GANs), variational auto-encoders (VAEs), and transformer models, including multimodal transformer models. Foundation models capture general knowledge, semantic representations, and patterns and regularities in or from the data, making them capable of performing a wide range of downstream tasks. In some scenarios, a foundation model may be fine-tuned for specific downstream tasks. Foundation models include BERT (Bidirectional Encoder Representations from Transformers) and ResNet (Residual Neural Network). Foundation models may be multimodal or unimodal depending on the modality or modalities of the inputs (discussed infra). Types of foundation models may be broadly classified as or include pre-trained models, base models, and knowledge models, depending on the particular characteristics or usage of the model.

Large language models (LLMs) are a unimodal type of foundation model which is designed to process and generate natural language text. These models are trained on massive amounts of text data and learn to generate coherent and contextually relevant responses given a prompt or input text. LLMs are capable of sophisticated language understanding and generation capabilities due to their trained capacity to capture intricate patterns, semantics and contextual dependencies in textual data. In some scenarios, LLMs or other generative AI models can incorporate additional modalities, such as combining images or audio with textual input to generate multimodal outputs. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, ERNIE (Enhanced Representation through kNowledge Integration) models, T5 (Text-to-Text Transfer Transformer), and XLNet models are types of transformer models which have been pretrained on large amounts of text data using a self-supervised learning technique called masked language modeling. Indeed, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses which are novel, open-ended, and unpredictable.

In various implementations of the disclosed technology, a software application executed on a computing device communicates with an online learning platform hosted on one or more servers in a data center remote from the computing devices. The software is capable of providing a relevant user experience to reviewers and/or observed users. In an observed user-centric experience, the software allows observed users to draft a prompt for submittal to a foundation model and provides observed users with suggestions for amending the prompt before and/or after submitting the prompt to the foundation model. In the observed user-centric experience, the software also allows observed users to review, complete, and turn-in assignments. In a reviewer-centric experience, the software allows reviewers to create, define, and post prompt assignments, as well as to review and grade turned-in assignments.

In the same or alternative implementation, the software application communicates with an online service, which may or may not include the learning platform, to obtain insight information indicative of the progress (or lack thereof) of observed users with respect to prompting. The software application displays the insights in a manner that allows a reviewer to review the progress of a group of observed users as a whole, as well as to drill-down into the data on a per-user basis. The user experience provided by the software application allows a reviewer to quickly and easily understand the progress that an observed user is making with respect to their proficiency when constructing prompts.

While reference is made throughout to prompt assignments, it may be appreciated that the features and functionality described herein with respect to prompt assignments apply as well to any type of assignment having a prompt drafting component. Similarly, while reference is made throughout to reviewer and observed user roles, the features and functionality described herein apply as well to other types of roles where one user provides instruction for the benefit of another user. For example, the features and functionality described herein with respect to reviewer-roles apply as well to managers instructing employees, team leaders guiding team members, teachers instructing observed users, and the like.

Furthermore, the technology disclosed herein may incorporate a foundation model service hosting a foundation model, such as an LLM service hosting an LLM, to teach a variety of subjects beyond prompt drafting instruction. Example subjects include subjects in the social sciences (e.g., history, geography), scientific subjects (e.g., biology, chemistry, astronomy), math subjects (e.g., geometry, statistics, game theory), subjects in the visual arts, (e.g., fine art appreciation, photography, art history), etc.

Various technical effects that result from the enhanced user experiences disclosed herein may be apparent. At a high level, the instruction provided to individual users form the basis for improved instruction with respect to prompt drafting skills and techniques. The improved instruction, when applied by observed users or others in such roles, results in improved prompts. In turn, the improved prompts reduce human-computer conversational churn by eliciting enhanced responses from foundation models, thereby reducing the need for multiple prompt submissions to obtain the desired response. For example, the replies returned by a foundation model engine may be more factual (less weighted towards opinion), more accurate (less misleading), and overall, of a higher quality than without such improvements.

In the aggregate, a reduction in conversational churn reduces the computing resources required of foundation model engines that process the prompts. A reduction in conversational churn may reduce demand on a global scale for the energy required to power modern foundation model engines. At a more local level, reduced conversational churn consumes less battery power (e.g., on mobile devices) since fewer queries are needed, to say nothing of improving the basic user experience with respect to conversational AI. Improved prompting also reduces the time it takes a user to find and access relevant information, time which may be spent on other productive activities.

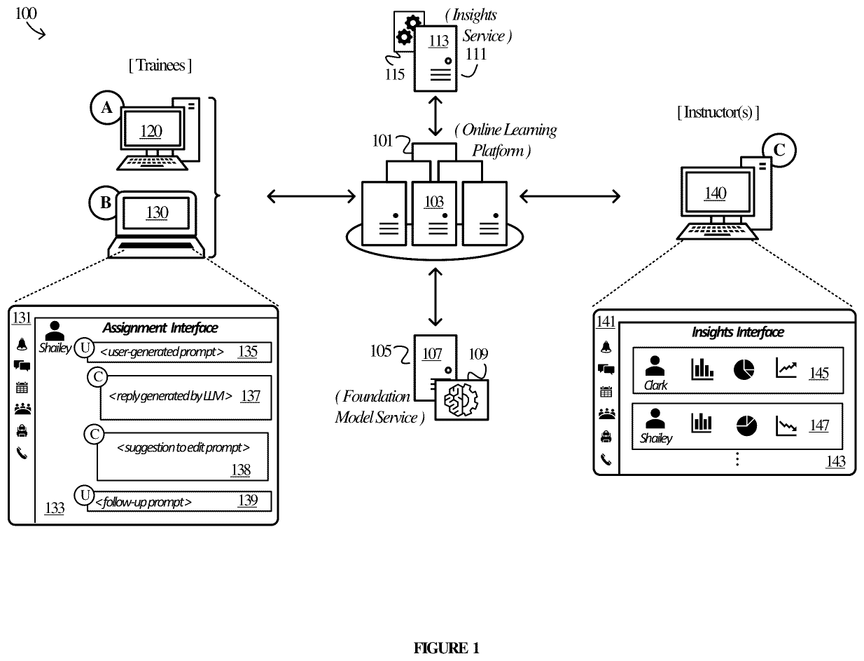

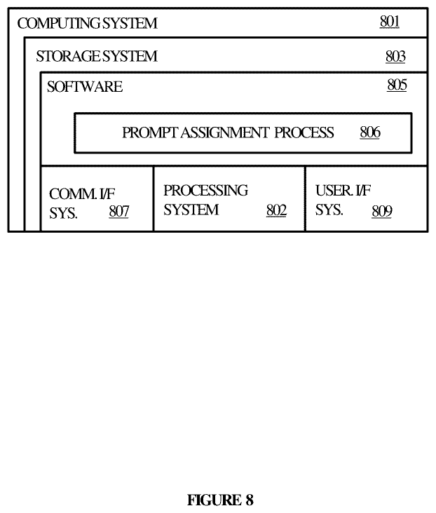

FIG. 1 illustrates an operational environment 100 in an implementation of an enhanced prompt assignment associated with a learning platform. Operational environment 100 includes learning platform 101, foundation model service 105, and insights service 111, as well as computing devices 120, 130, and 140. Learning platform 101 employs one or more server computers 103 co-located with respect to each other or distributed across one or more data centers. Example servers include web servers, application servers, virtual or physical servers, or any combination or variation thereof, of which computing device 801 in FIG. 8 is broadly representative.

Computing devices 120, 130, and 140 communicate with learning platform 101 via one or more internets and intranets, the Internet, wired and wireless networks, local area networks (LANs), wide area networks (WANs), or any other type of network or combination thereof. Examples of computing devices 120, 130, and 140 include personal computers, tablet computers, mobile phones, gaming consoles, wearable devices, Internet of Things (IoT) devices, and any other suitable devices, of which computing device 801 in FIG. 8 is also broadly representative.

Broadly speaking, learning platform 101 provides one or more services to end points such as computing devices 120, 130, and 140. Example services include collaboration applications and services, productivity application services, a prompt coach service, a foundation model service, and the like. The various features and functionality provided by the applications and services available through learning platform 101 are provided in the context of applications running locally with respect to end-users. For example, computing devices 120, 130, and 140 execute applications that provide a local user experience and that interface with learning platform 101. Example applications include collaborative communication applications capable of organizing users into groups (e.g., observed users in a class). The applications running locally with respect to computing devices 120, 130, and 140 may be natively installed and executed applications, applications that run in the context of a web-browser, mobile applications, or any other type of application capable of interfacing with learning platform 101 and providing a user experience.

Learning platform 101 includes an integration (e.g., an application programming interface) with foundation model service 105 to support conversational interactions between observed users and foundation model-powered chatbots and other types of AI tools. Foundation model service 105 employs one or more server computers 107 co-located with respect to each other or distributed across one or more data centers, of which computing device 801 in FIG. 8 is broadly representative. Foundation model service 105 hosts foundation model engine 109 on server computers 107. Foundation model engine 109 is representative of a foundation model-powered AI capable of interacting in a conversational manner via prompts generated by users of other applications and services, and replies generated by the foundation model engine in response to the prompts.

Learning platform 101 also includes an integration with insights service 111, which is capable of analyzing and reporting on the conversational interactions between observed users and foundation model engine 109. Insights service 111 employs one or more server computers 113 co-located with respect to each other or distributed across one or more data centers, of which computing device 801 in FIG. 8 is broadly representative. Insights service 111 hosts insights engine 115 on server computers 113. Insights engine 115 is representative of analytics software capable of capturing the prompts and replies exchanged between user applications and foundation model engine 109, analyzing the interactions, and providing insights about the users' prompting.

Learning platform 101 and insights service 111 provide insights to reviewers and observed users with respect to the prompts constructed and submitted by the observed users. Here, user A and user B are observed users, while user C is a reviewer. Users A and B construct prompts and consume insights (e.g., suggested revisions to the prompts) in the context of software applications running on computing devices 120 and 130, respectively. User C also consumes insights (e.g., progress of an observed user on a prompt assignment) in the context of software running on computing device 140.

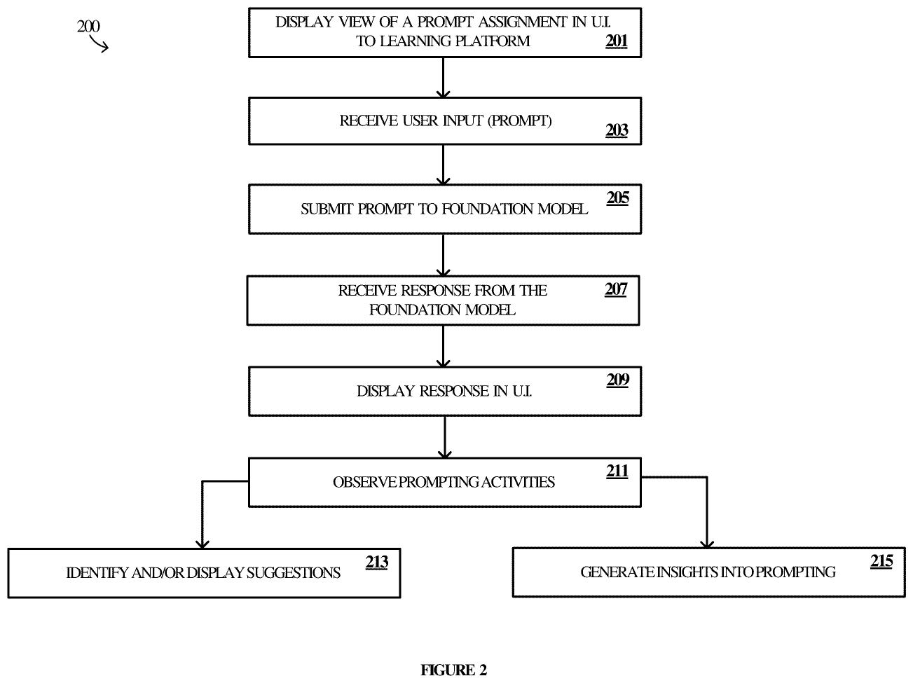

A technical improvement to such environments disclosed herein allows reviewers not only the opportunity to obtain prompting-related insights about observed users, but also to provide observed users opportunities to improve their prompt drafting skills that heretofore have not been available. In particular, FIG. 2 illustrates a process employed by learning platform 101 to collect prompting signals within the context of a learning platform and dynamically surface prompting-related insights to users. The users may be, for example: observed users (those whose prompting is being observed) and reviewers (those reviewing the progress of observed users). In some cases, the observed user and the reviewer may be one in the same.

Turning to FIG. 2, prompt assignment process 200 represents a method for providing enhanced prompting assignments. Prompt assignment process 200 is implemented in program instructions in the context of a software application, service, micro-service, or combination thereof running on one or more computing devices. The program instructions direct the computing devices to operate as follows, referring to a computing device in the singular for the sake of simplicity.

To begin, a computing device implementing prompt assignment process 200 displays a view of a prompt assignment in a user interface (UI) to a learning platform (step 201). The device receives user input including a prompt associated with the prompt assignment (step 203). The user input is received in the context of the prompt assignment. The user input may include text of an original prompt, an edit or other revision applied to the text of the original prompt, etc.

The device submits the prompt to a foundation model (step 205). The submitted prompt elicits a reply from the foundation model. The foundation model generates a response to the prompt and transmits the response to the device. The device receives the response from the foundation model (step 207) and displays the response in a user interface (step 209).

In some implementations, the computing device observes the prompting activities of an observed user associated with a foundation model service (step 211) and displays suggestions for editing or otherwise refining a prompt (step 213). Observing the prompting may include, for example, observing the text of the prompt constructed in association with the context of the prompt assignment. Observing the prompting may also include observing revisions made to a prompt subsequent to an option being surfaced in a user interface that suggests a revision to the prompt. Observing the prompting may also include observing prompts submitted to the foundation model service, as well as observing replies to the prompts from the foundation model service. Observing the prompting may further include observing the actions of observed users with respect to the replies such as click-throughs to links supplied in the replies, dwell time over the replies, and the like.

Having observed the prompting activities, the computing device proceeds to identify suggestions for improving the prompting activities of the observed user (step 213). For example, the computing device may flag prompts that are not on-task or that are objectively inappropriate and may provide feedback to highlight the context of the assignment. The computing device may suggest an edit to the text of a prompt that would improve the conciseness of the prompt, the focus of the prompt, the topic of the prompt in light of the context of the prompt assignment, etc. The computing device may generate an option that suggests a revision to a prompt based on the text of the prompt and a context of the prompt assignment. For example, the computing device may identify the context of the prompt assignment and determine that the prompt does (or does not) include the context and surface the option based on the determination. If the prompt does not include the context, then the option may suggest rewriting the prompt to focus the context. Alternatively, if the prompt does include the context, then the option may include a suggestion to refine the prompt's conciseness, etc.

In the same or other implementation, the computing device observes the prompting activities of an observed user associated with a foundation model service and displays insights (e.g., to a reviewer) about prompting behavior of one or more observed users. The computing device may organize the prompting activities into conversations between the observed user, the learning platform, and the foundation model, and may classify the conversations as belonging to one or more of a set of categories based on characteristics of the prompts, replies, and user actions. The categories may include multiple subsets of categories such as one associated with prompting types, one associated with prompting topics, and one associated with prompting quality. Categories associated with prompting types may include a creative category, a productivity category, a learning category, and a research category. Categories associated with prompting topics may include an off-task category, an on-task category, and an inappropriate content category. Categories associated with prompting quality may include a high-quality category and a low-quality category.

Characteristics of the prompts include the content of the prompts, while characteristics of the replies include the content of the replies. Characteristics of an observed user's actions include a dwell time over the replies, a frequency of using a stop-replying feature with respect to the replies, and a frequency of click-throughs with respect to the content of the replies.

Having observed the prompting, the computing device proceeds to identify, on the per-user basis with respect to each of the group of observed users, insights into the prompting (step 215). Example insights include statistics related to the classification categories such as counts, trends, and the like for each category or sub-category. Other insights include information flagging prompts that are not on-task or that are objectively inappropriate. The insights may include groupings of conversations by topic allowing a reviewer or an observed user to view a particular conversation to monitor or review an exchange. Other example insights include word clouds derived from the content in the prompts and replies. In some implementations, the insights may include citation analysis such as a rate of click-throughs to a resource cited in a reply.

As mentioned, the insights may relate to the classification categories, including prompting quality. For example, the insights may include a measure of dwell time by an observed user with respect to a reply provided by a foundation model, as well as a dwell time by the observed user over content provided by a link in a reply. The insights may also include analysis with respect to how many traditional Internet searches turned into chat conversations with a foundation model service.

The computing device may also enable display of the insights in a user interface associated with a reviewer. Enabling display of the insights may include, for example, sending information indicative of the insights to a client device for display in a user interface associated with a reviewer. The information may be sent in the context of a webpage, an image, or another object or collection of objects that may be rendered in a user interface on an end point. For instance, the insights may be displayed by a component of an application that includes an integrated insights tool or add-in application, or by a component of a dedicated application specific to insights. The reviewer may navigate the user interface to consume insights on specific observed users or groups of users in order to provide them with coaching and instruction with respect to their prompting capabilities.

Referring back to FIG. 1, the following describes an application of prompt assignment process 200 with respect to the elements of operational environment 100. In operation, users A and B (observed users) may engage with foundation model service 105 in a variety of ways including through conversational components of local applications running on computing devices 120 and 130, respectively. The proficiency of the users with respect to prompting may be monitored and evaluated by user C (a reviewer) via an application or tool running on computing device 140. The users supply natural language input in the form of typed text, spoken (audible) words, etc. that form the basis of a prompt to a foundation model. Foundation model service 105 receives the prompt, processes it, and returns a reply that (presumably) addresses a request, task, or other such statement included in the prompt. The success of the prompt depends at least partly on the prompting proficiency of the observed user. That is, the relative skill of the observed user with respect to prompting will play a large role in whether the observed user's prompts elicit replies that are helpful, informative, and generally useful.

In the scenario illustrated in FIG. 1, users A and B operate computing devices 120 and 130, respectively, in an observed user role and user C operates computing device 140 in a reviewer role with respect to users A and B. For example, user C may be a teacher of a class, while users A and B are observed users in the class. An application running on computing device 130 provides user B with a user interface 131 to learning platform 101 from the perspective of an observed user role. For example, user B engages with learning platform 101 and foundation model service 105 via a user interface 131 to consider and complete assignments, to engage with foundation model service 105, and the like. User interface 131 includes a feature menu that includes various icons for navigating to different modalities of the application. The icons include, for example, an alarm icon for viewing reminders, a chat icon for messaging other users, a calendar icon for navigating to a calendar module, a teams icon for creating or navigating to different teams, a backpack icon for accessing homework assignments, and a phone icon for placing phone calls. A user may click-on or otherwise select any of the icons to navigate to their corresponding modules. Here, it is assumed for exemplary purposes that user B selected the backpack icon in order to navigate to assignment interface 133 in user interface 131.

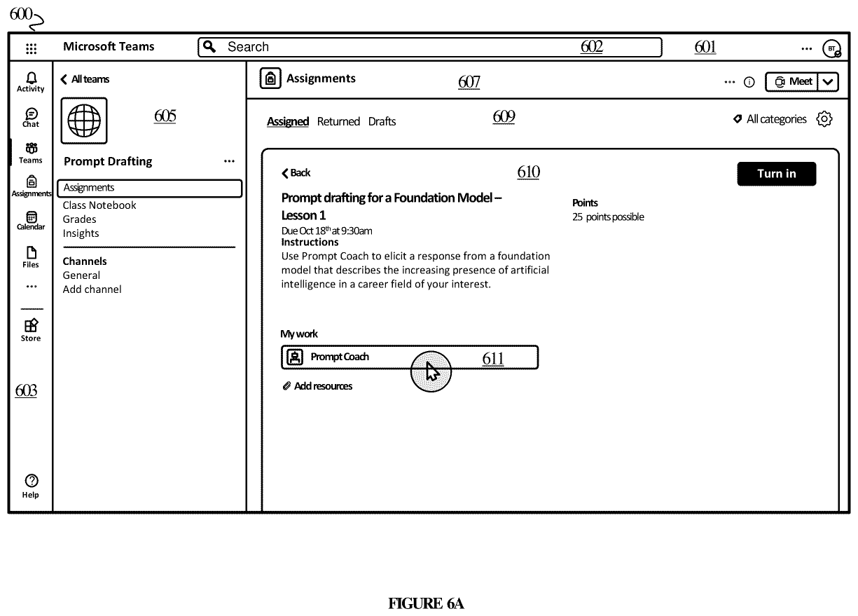

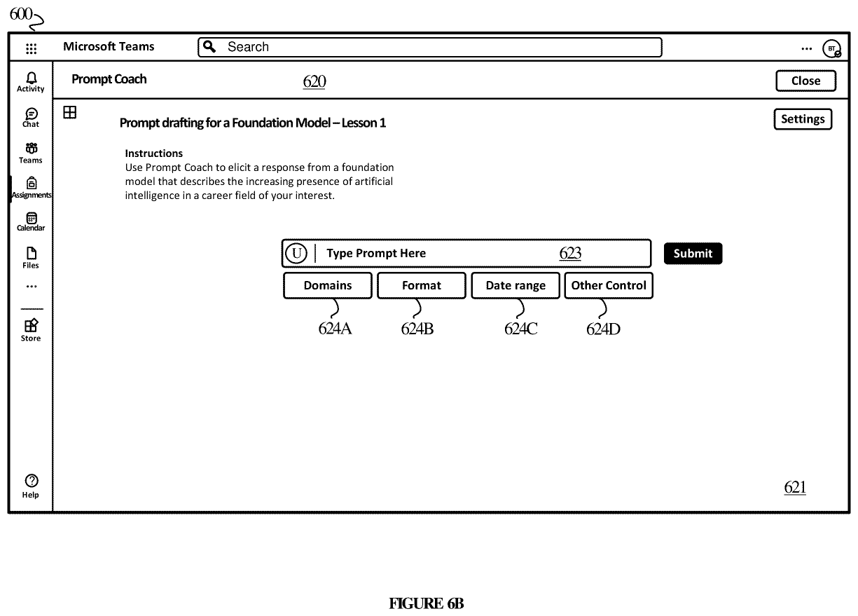

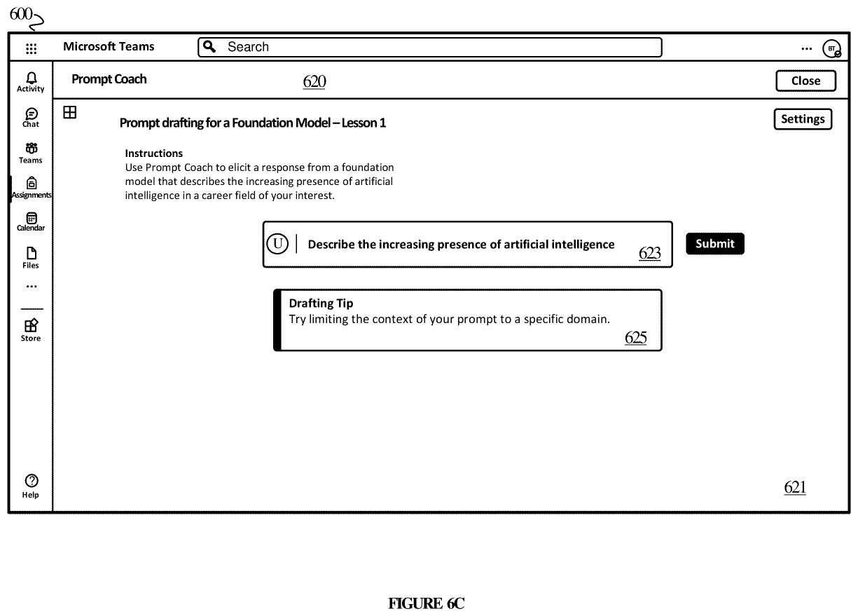

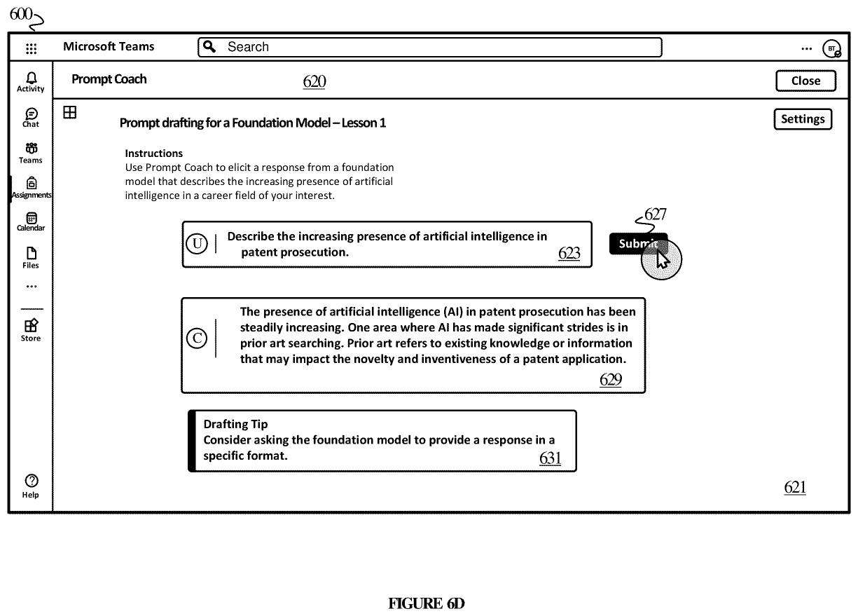

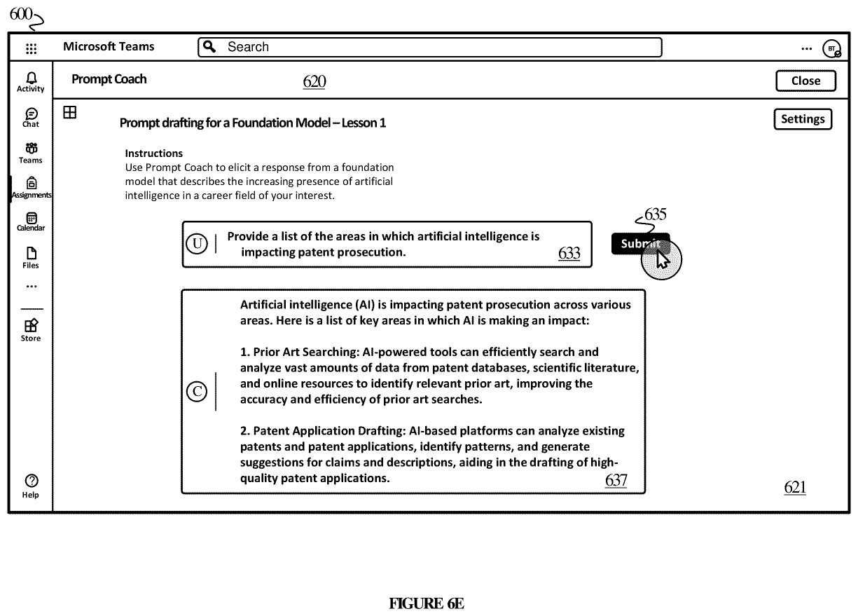

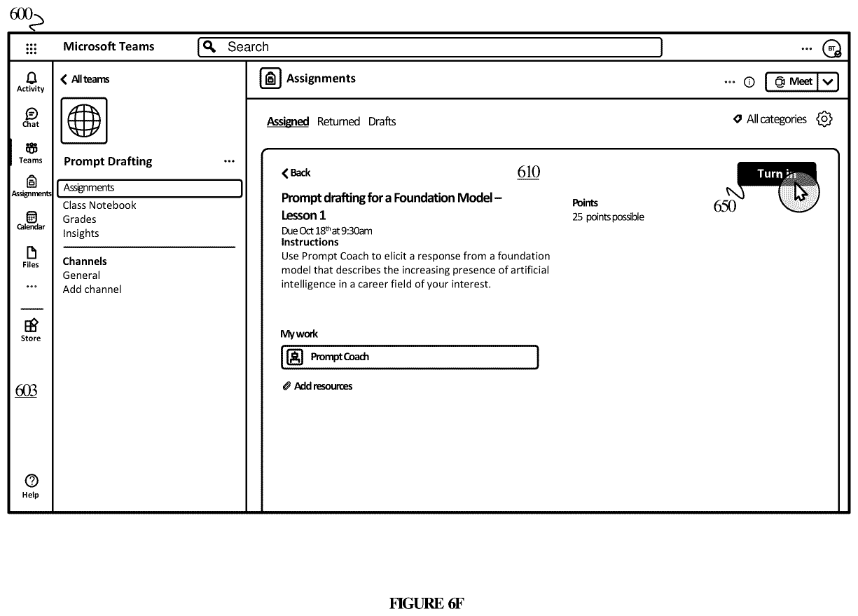

Assignment interface 133 is representative of one view in a series of views that may be provided by the application as an observing user navigates user interface 131, more detailed examples of which are described below with respect to FIGS. 6A-6F. User interface 131 includes assignment interface 133 through which user B may construct prompts and submit the prompts to foundation model service 105, as well as consume and interact with replies from foundation model service 105. Assignment interface 133 includes input components 135 and 139 for receiving natural language input from the observed user for generating the prompts. Assignment interface 133 also includes response component 137, which is representative of components through which the application surfaces the replies from foundation model service 105. Assignment interface 133 further includes option component 138, which is representative of components through which the application surfaces suggestions for editing the user input (e.g., received from insights services 111), such as a suggestion to edit or otherwise refine a prompt received via input component 135, etc. While illustrated as a text-based interface, it may be appreciated that one or both of the inputs and outputs could be provided in accordance with a different modality such as speech, audio, or other modes of input and output.

In contrast, an application running on computing device 140 provides user C with a user interface 141 to learning platform 101 from the perspective of a reviewer role. A user in a reviewer role navigates and interacts with user interface 141 to create and manage assignments, to review insights of prompting activities, and the like. User interface 141 includes a feature menu that includes various icons for navigating to different modalities of the application. The icons include, for example, an alarm icon for viewing reminders, a chat icon for messaging other users, a calendar icon for navigating to a calendar module, a teams icon for creating or navigating to different teams, a backpack icon for viewing homework assignments, and a phone icon for placing phone calls. A user may click-on or otherwise select any of the icons to navigate to their corresponding modules. Here, it is assumed for exemplary purposes that user C selected the backpack icon in order to navigate to insights view 143 in user interface 141.

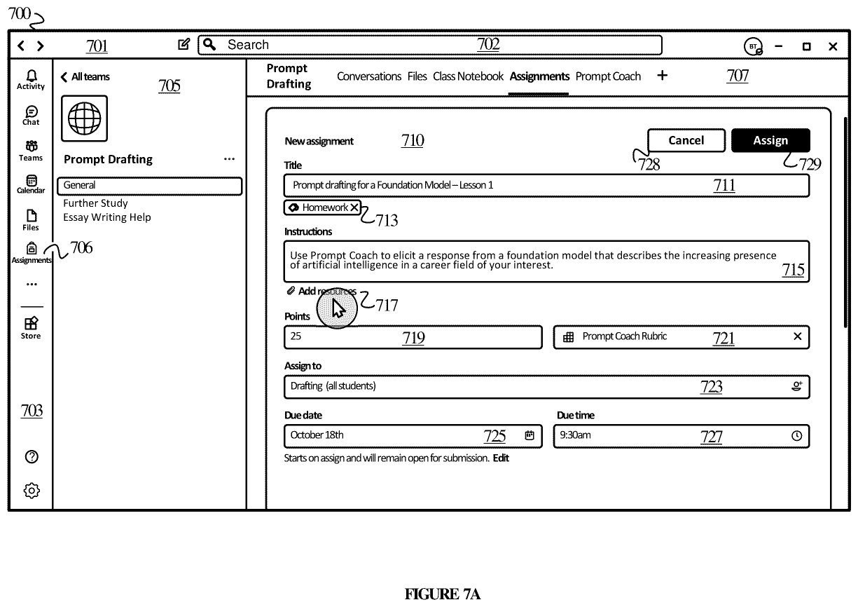

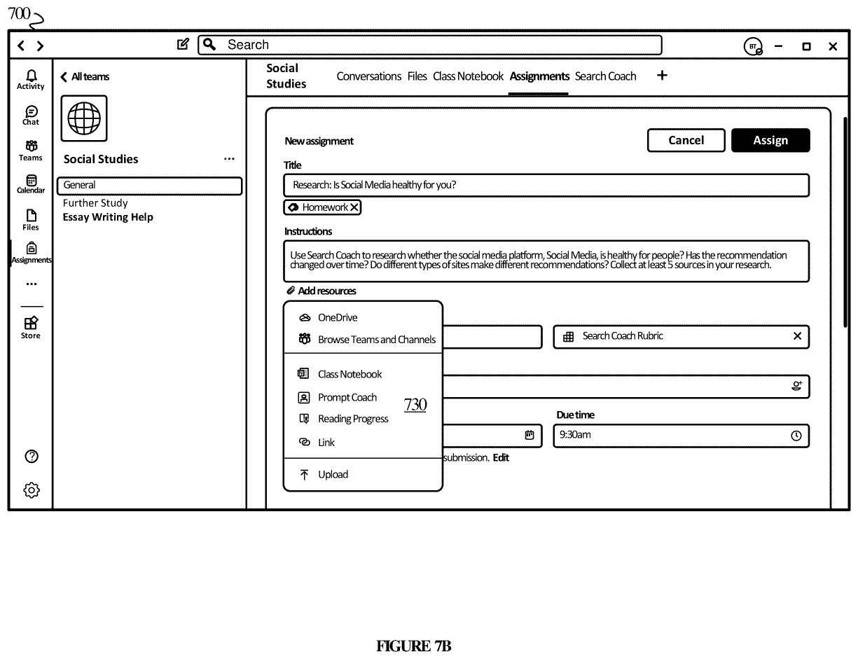

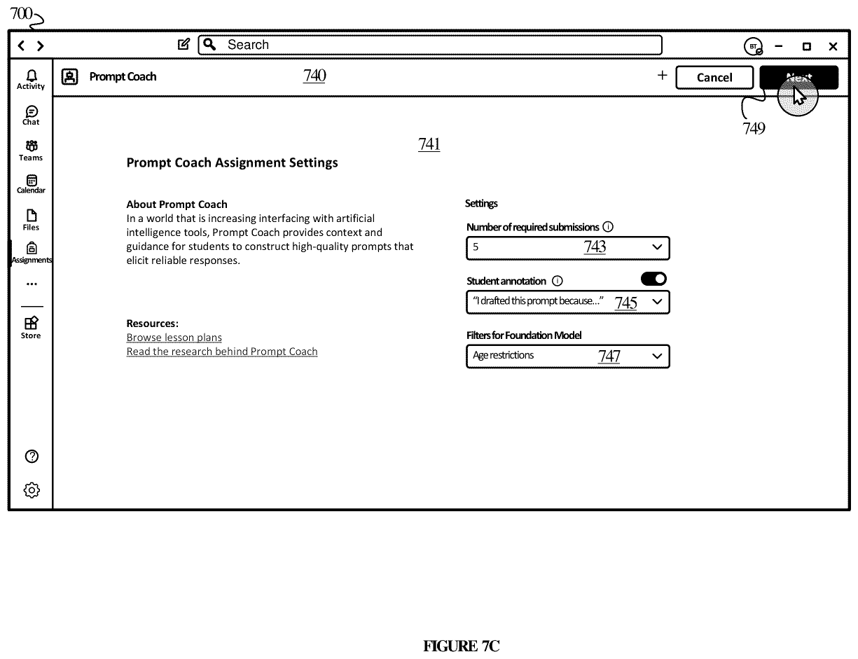

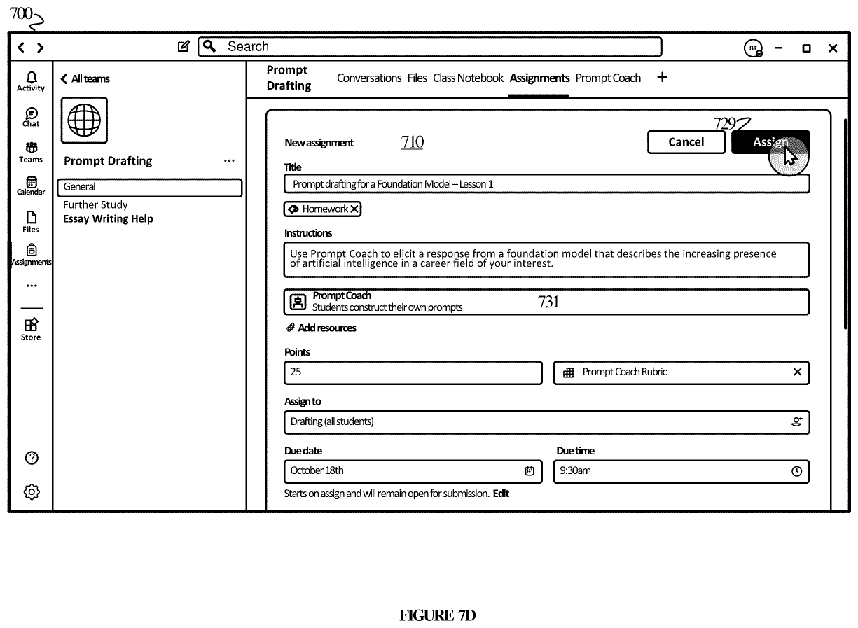

Insights view 143 is representative of one view in a series of views that may be provided by the application as a reviewing user navigates user interface 141, more detailed examples of which are described below with respect to FIGS. 7A-7D. User interface 141 includes insights view 143 through which user C may obtain and consume insights with respect to the prompting by user A and user B. Insights interface 143 includes components 145 and 147 that are representative of graphical user interface elements through which insights about prompting behavior may be displayed. For example, component 145 includes various charts and graphs that are representative of statistics, analysis, and other such information related to the prompting of user A (“Clark”), while component 147 includes the same with respect to user B (“Shailey”).

In the same or alternate embodiment, user C may select the backpack icon to navigate to an assignments view in user interface 141 (not shown). The assignment interface may include various features and functionality that allow the user to create, configure, and post prompt assignments. For example, the assignments view may include a title block for inputting the name of an assignment, an instructions block for inputting detailed instructions for completing the assignment, a points block for inputting the number of points allocated to the assignment for grading purposes, and a resource block for inputting the number of research resources required for the assignment.

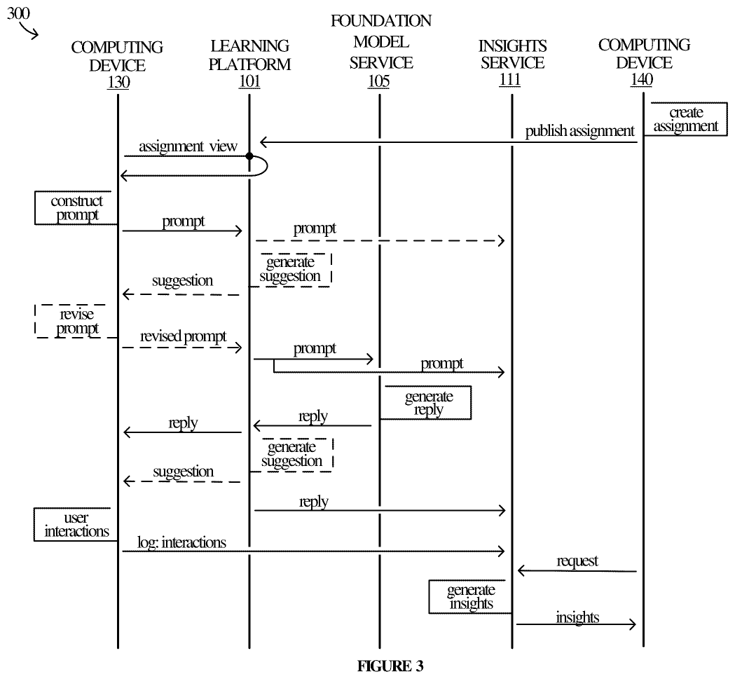

FIG. 3 illustrates a brief operational scenario 300 to further highlight an application of prompt assignment process 200 with respect to various components of operational environment 100. It is assumed for exemplary purposes that users A and B are observed users, and user C is a reviewer. The operations are illustrated with respect to computing device 130 associated with an observed user (user B) and computing device 140 associated with a reviewer (user C). It may be appreciated that the features and functionality described with respect to computing device 130 would apply as well to computing device 120.

In operation, user C engages with computing device 140 to create and assign a prompt assignment to a group of users that include users A and B. Computing device 140 posts the assignment to learning platform 101. The observed users, engaged with learning platform 101 via their respective client applications (e.g., computing device 130), are able to view, complete, and turn in the assignment.

In particular, computing device 130 retrieves a view of the assignment and displays the assignment view on a screen for user B to consider. The assignment view includes details of the assignment, such as its title, instructions for completing the assignment (including context for drafting a prompt), the deadline for the assignment, the points allocation for the assignment, etc. The assignment view also includes a text field through which to draft a prompt associated with the assignment.

User B constructs a prompt, e.g., via the text field, and computing device 130 sends the prompt, via an application on computing device 130, to learning platform 101. Subsequent to receiving the prompt, learning platform 101 may record the prompt and/or send the prompt to insight service 111. Learning platform 101 may also analyze the prompt to identify a means for improving the prompt, such as improving the conciseness of the prompt, the focus of the prompt, the topic of the prompt in light of the context of the prompt assignment, etc. Subsequent to identifying the means for improving the prompt, learning platform 101 may generate a suggestion that includes the means for improving the prompt and send the suggestion to computing device 130 for display in a user interface.

After reviewing the suggestion, user B may revise the original prompt, via the text field, and computing device 130 may send the revised prompt, via the application on computing device 130, to learning platform 101. Learning platform 101 then routes to foundation model service 105 either the original prompt, if no revisions were made, or the revised prompt. Learning platform 101 also sends to insights service 111 a copy of the prompt submitted to foundation model service 105. In some scenarios, the application on computing device 130 may send the prompt to one or both of foundation model service 105 and insights service 111 directly, rather than via learning platform 101.

Foundation model service 105 receives the prompt, generates a reply, and returns the reply to computing device 130 either through learning platform 101 or directly to computing device 130. After receiving the reply, learning platform 101 may analyze the reply and the submitted prompt to identify a means for improving the submitted prompt. Subsequent to identifying the means for improving the submitted prompt, learning platform 101 may generate a suggestion that includes the means for improving the submitted prompt and send the suggestion to computing device 130 for display in a user interface.

The application on computing device 130 displays the reply and/or the suggestion for user B's consideration. User B further interacts with the application on computing device 130 (e.g., formulates a follow-up prompt, clicks a link in the reply, submits the assignment, or the like). User B's interactions are logged by the application on computing device 130 and communicated to insights service 111. Alternatively, the interactions may be communicated to insights service 111 via learning platform 101.

Insights service 111 processes the interactions, user B's original prompt, user B's revised prompts, suggestions provided by learning platform 101, and the like, to develop prompting insights about user B. Insight service 111 supplies the prompting insights to an application on computing device 140 upon request, automatically, or at some other interval. For example, user C may navigate to a page that references user B, thereby triggering a request by user C's application to insights service 111 for insights about user B. Insights service 111 responsively generates the insights and delivers them to the application on computing device 140 for display to user C.

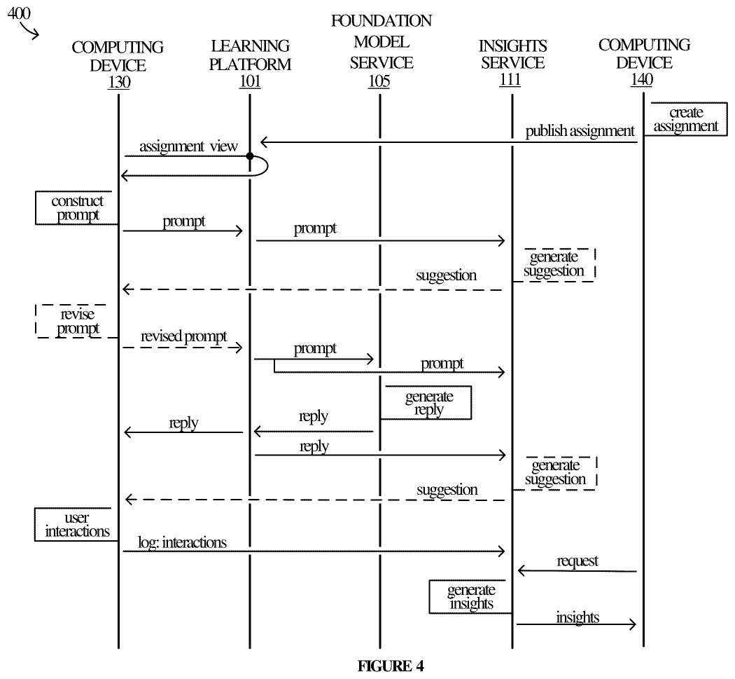

FIG. 4 illustrates a brief operational scenario 400 to further highlight an application of prompt assignment process 200 with respect to various components of operational environment 100. It is assumed for exemplary purposes that users A and B are observed users, and user C is a reviewer. The operations are illustrated with respect to computing device 130 associated with an observed user (user B) and computing device 140 associated with a reviewer (user C). It may be appreciated that the features and functionality described with respect to computing device 130 would apply as well to computing device 120.

In operation, user C engages with computing device 140 to create and assign a prompt assignment to a group of users that include users A and B. Computing device 140 posts the assignment to learning platform 101. The observed users, engaged with learning platform 101 via their respective client applications (e.g., computing device 130), are able to view, complete, and turn in the assignment.

In particular, computing device 130 retrieves a view of the assignment and displays the assignment view on a screen for user B to consider. The assignment view includes details of the assignment, such as its title, instructions for completing the assignment (including context for drafting a prompt), the deadline for the assignment, the points allocation for the assignment, etc. The assignment view also includes a text field through which to draft a prompt associated with the assignment.

User B constructs a prompt, via the text field, and computing device 130 sends the prompt, via an application on computing device 130, to learning platform 101, which routes the prompt to insights service 111. Subsequent to receiving the prompt, insights service 111 may analyze the prompt to identify a means for improving the prompt, such as improving the conciseness of the prompt, the focus of the prompt, the topic of the prompt in light of the context of the prompt assignment, etc. Subsequent to identifying the means for improving the prompt, insights service 111 may generate a suggestion that includes the means for improving the prompt and send the suggestion to computing device 130 for display in a user interface. Alternatively, insights service 111 may send the suggestions to computing device 130 via learning platform 101.

After reviewing the suggestion, user B may revise the original prompt, via the text field, and computing device 130 may send the revised prompt, via the application on computing device 130, to learning platform 101. Learning platform 101 then routes to foundation model service 105 either the original prompt, if no revisions were made, or the revised prompt. Learning platform 101 also sends to insights service 111 a copy of the prompt submitted to foundation model service 105. In some scenarios, the application on computing device 130 may send the prompt to one or both of foundation model service 105 and insights service 111 directly, rather than via learning platform 101.

Foundation model service 105 receives the prompt, generates a reply, and returns the reply to computing device 130 either through learning platform 101 or directly to computing device 130. Learning platform 101, after receiving the reply, sends the reply to insights service 111 for analysis. Insights service 111 may then analyze the reply and the submitted prompt to identify a means for improving the submitted prompt. Subsequent to identifying the means for improving the submitted prompt, insights service 111 may generate a suggestion that includes the means for improving the submitted prompt and send the suggestion to computing device 130 for display in a user interface. Alternatively, insights service 111 may send the suggestions to computing device 130 via learning platform 101.

The application on computing device 130 displays the reply and/or the suggestion for user B's consideration. User B further interacts with the application on computing device 130 (e.g., formulates a follow-up prompt, clicks a link in the reply, submits the assignment, or the like). User B's interactions are logged by the application on computing device 130 and communicated to insights service 111. Alternatively, the interactions may be communicated to insights service 111 via learning platform 101.

Insights service 111 processes the interactions, user B's original prompt, user B's revised prompts, suggestions provided by learning platform 101, and the like, to develop prompting insights about user B. Insight service 111 supplies the prompting insights to an application on computing device 140 upon request, automatically, or at some other interval. For example, user C may navigate to a page that references user B, thereby triggering a request by user C's application to insights service 111 for insights about user B. Insights service 111 responsively generates the insights and delivers them to the application on computing device 140 for display to user C.

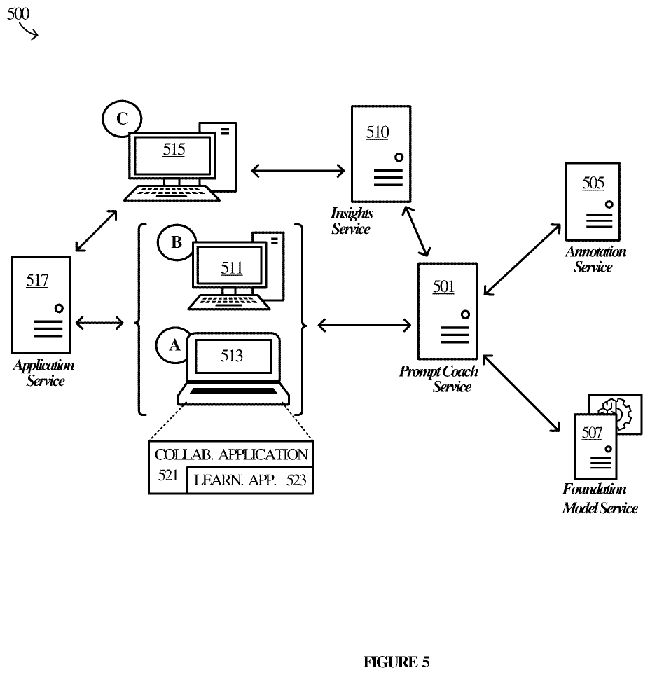

FIG. 5 illustrates operational environment 500 in another implementation of an enhanced prompt assignment associated with a learning platform. Operational environment 500 includes prompt coach service 501, annotation service 505, foundation model service 507, insights service 510, and application service 517. Operational environment 500 also includes computing devices 511-515, which interface with one or more of the aforementioned components of the environment.

Prompt coach service 501, annotation service 505, and insights service 510 are each representative of software services, micro-services, or the like, implemented on one or more server computers co-located or distributed across one or more data centers connected to computing devices 511-515. Application service 517 is also representative of a software service, micro-service, or other such applications implemented on one or more server computers co-located or distributed across one or more data centers connected to computing devices 511-515. Example servers include web servers, application servers, virtual or physical, or any combination or variation thereof, of which computing device 801 in FIG. 8 is again broadly representative.

Computing devices 511-515 communicate with one or more of prompt coach service 501, annotation service 505, foundation model service 507, insights service 510, and application service 517 via one or more internets and intranets, the Internet, wired and wireless networks, LANs, WANs, or any other type of network or combination thereof. Examples of computing devices 511-515 include personal computers, tablet computers, mobile phones, gaming consoles, wearable devices, IoT devices, and any other suitable devices, of which computing device 801 in FIG. 8 is also broadly representative.

Prompt coach service 501 provides an interface through which prompt assignment tools on computing devices 511 and 513 access foundation model service 507 to perform enhanced prompt assignments that include chat-based integration with foundation model engines. Annotation service 505 is representative of a service capable of annotating prompts at the request of prompt coach service 501 to provide context with respect to a prompt constructed and/or revised by an observed user. For example, annotation service 505 may identify a constructed prompt as being concise, in concise, focused, unfocused, etc. (e.g., based on the assignment). Annotation service 505 may also be capable of annotating foundation model replies at the request of prompt coach service 501 to provide context with respect to chat replies provided by foundation model service 507. Additionally, annotation service 505 may be capable of determining a reliability of a foundation model reply and providing the reliability to prompt coach service 501 for surfacing in a user interface (e.g., of computing device 513).

Insights service 510 is representative of a service capable of observing the prompt drafting skills of observed users, analyzing the drafting skills, and delivering relevant insights about their drafting skills. Insights service 510 communicates with prompt coach service 501 either in-line or out-of-band with respect to prompts flowing through the service to obtain indications of the words, phrases, and other characteristics of the prompts being constructed and submitted to foundation model service 507. For example, insights service 510 may obtain copies of the prompts, allowing insights service 510 to parse the prompts to identify their characteristics and classify them accordingly. Insights service 510 develops a record of the constructed prompts and other application usage on a per-user basis that it may then leverage when developing prompting insights.

Application service 517 is representative of any application provided as a service that users may interact with via corresponding applications on their computing devices. Examples of application service 517 include—but are not limited to—collaboration services, communication services, productivity services, gaming services, and business application services. The local application(s) corresponding to application service 517 (e.g., a collaboration application, productivity application, or the like) are capable of hosting classroom applications in their execution contexts. Here, classroom application 521 is representative of one such application that hosts learning application 523 and provides an observed user-centric user experience. An observed user may engage with classroom application 521 to access its features and functionality, for example those related to an online classroom experience in the context of a learning platform. The observed user may also engage with learning application 523—in the context of classroom application 521—to access its features and functionality (i.e., those of learning application 523).

In a brief example, an observed user may engage with classroom application 521 to chat with reviewers, make voice or video calls to reviewers, join conference calls between other observed users and/or a reviewer, share documents, receive homework assignments, complete homework assignments, submit the homework assignments, or otherwise collaborate with reviewers and/or other observed users. Such interactions may involve classroom application 521 connecting to application service 517 and exchanging data with application service 517. At the same time, the observed user may engage with learning application 523 to construct prompts, submit prompts to a foundation model to elicit a response, view replies from foundation models, and engage with an AI-powered chatbot to enhance the prompt drafting experience.

Some reviewers-such as a teacher, manager, or person in charge of a group—may experience learning application 523 in a reviewer mode. In the reviewer mode, the reviewer is provided with tools to facilitate prompt drafting activities, such as input fields for drafting and publishing a prompt assignment, filter options selectable to apply a filter that limits the scope of a reply from a foundation model as eligible for display, etc. Example filters include an age filter that limits the scope of the replies to an age range, a content filter that limits the scope of the replies to a range of content, a reviewer constraint that is specified by a reviewer of the prompt assignment, etc. While in the reviewer mode, the reviewer is also provided with insights into the prompting habits, patterns, and proficiency of the observed users in the group. For example, while in the reviewer mode, a reviewer may view a list of prompts drafted and/or submitted to the foundation model by one or more observed users. The reviewer may be provided with an evaluation of the list of prompts that identifies a progression of the list of prompts (e.g., did a focus of the prompt(s) change overtime, did the prompts become more concise). Based on the progression, the reviewer may determine and/or be provided a determination of whether the observed user understood the prompt assignment. The determination may be a textual summary (e.g., “the observed user demonstrated a high proficiency”), a numerical summary (e.g., 70% proficiency). While in the reviewer mode, the reviewer may be provided a conciseness of each prompt and/or a progression of the conciseness over time.

FIGS. 6A-6F illustrate the observed user experience in an implementation that is representative of users A and B's experience described with respect to FIGS. 1, 3, and 4 above. Related to FIGS. 6A-6F are FIGS. 7A-7E, which illustrate a reviewer-centric user experience in an implementation that is representative of the user C's experience described with respect to FIGS. 1, 3, and 4 above.

In particular, FIGS. 6A-6F illustrate the observed user experience when working on a newly assigned prompt assignment. FIG. 6A illustrates user interface 600, which includes an application frame 601 across the top of the user interface that includes various features such as search box 602 for searching for contacts, files, chats, and the like in the collaboration application of a learning platform. Application frame 601 also includes controls for minimizing, maximizing, or closing the application. Along the left side of user interface 600, a feature bar 603 includes icons for launching various modules of the application. For example, feature bar 603 includes icons for alerts, messaging, team management and/or participation, a calendar module, files, an assignments module, and an app store module. In this example, the user has already navigated to a teams module for a Prompt Drafting team.

Panel 605 in user interface 600 is a base page of the teams module for Prompt Drafting in the observed user-centric view of the team. Panel 605 provides the user with basic information about the team and various features available through the team such as the ability to view assignments, a class notebook, grades, and insights. Here, it is assumed for exemplary purposes that the observed user has navigated to assignments view 607 of an assignment mode of the teams module.

Assignments view 607 is provided in the context of a classroom mode of the application. In the assignment mode, user interface 600 includes a menu 609 of assignment types including those that have been assigned, returned, and drafts. Selecting the assigned tab takes the user to a list of assigned assignments, whereas selecting the returned tab or drafts tab would take the user to a list of assignments returned by the reviewer or assignments in draft stage by the observed user, respectively. Here, the user has selected the assigned tab, which in this case takes the user directly to a view of an assigned assignment, represented by prompt assignment view 610.

Prompt assignment view 610 provides a view of an assignment specific to a prompt drafting lesson and is representative of the assignment created by the reviewer in FIGS. 7A-7D. Prompt assignment view 610 includes details about the assignment such as its title, instructions for completing the assignment, and the points allocated to the assignment. Prompt assignment view 610 also includes a control 611 corresponding to a prompt coach tool that may be linked to the assignment by a reviewer. The observed user may select control 611, which transitions user interface 600 to a prompt assignment mode detailed in FIG. 6B.

In response to the observed user selecting control 611 in FIG. 6A, user interface 600 transitions to the prompt assignment mode which includes prompt coach view 620 in FIG. 6B. Prompt coach view 620 includes a prompt coach page 621 in which details of the assignment are displayed such as the topic, instruction, or the like. Prompt coach page 621 includes various components of the prompt coach tool available for the observed user to use when constructing an input or otherwise completing an assignment. The components include input component 623 which provides a user interface to a foundation model through which the user supplies the user input, such as constructing a prompt that elicits a reply from the foundation model. The components may also include filter controls that the user may leverage to refine a context of the prompt. Example controls include a domain control 624A, a format control 624B, a timeframe control 624C, other control 624D, etc. Domain control 624A may be used to restrict the prompt to a domain specified by the reviewer, example domains, etc. Format control 624B may be used to restrict responses from a foundation model to specific output types, such as a list format, an essay format, a voice format (e.g., Shakespeare), an audience format (e.g., employer), etc. Timeframe control 624C may be used to filter responses based on time and date. Other filter controls are also possible and contemplated herein (e.g., other control 624D).

In FIG. 6C, the observed user enters a prompt into input component 623. Here, the prompt string reads: “Describe the increasing presence of artificial intelligence.” Prior to the user submitting the prompt, the application surfaces option 625 in prompt coach page 621. Option 625 provides tips for improving prompt drafting skills, for example, by suggesting alterations to make that may improve replies provided by foundation models. The observed user may consider the content displayed in option 625, which provides the following suggestion: “Try limiting the context of your prompt to a specific domain.” Option 625 may be surfaced in response to detecting a user input entered in input component 623, in response to an analysis of the user input entered in input component 623, in response to a comparison of the user input entered in input component 623 and the assignment, etc.

In FIG. 6D, the observed user updated the prompt entered into input component 623 to state: “Describe the increasing presence of artificial intelligence in patent prosecution.” The user submits the prompt to a foundation model (not shown) via component 627, which causes the application to send the prompt to the foundation model. The foundation model returns a reply responsive to the prompt, and the application surfaces the reply as response component 629. Subsequent and/or responsive to receiving the reply from the foundation model, the application surfaces option 631 in prompt coach page 621. Option 631 provides the following suggestion: “Consider asking the foundation model to provide a response in a specific format.” Option 631 may be surfaced in response to detecting a user input entered in input component 623, in response to an analysis of the user input entered in input component 623, in response to a comparison of the user input entered in input component 623 and the assignment, in response to an analysis of the reply, in response to a comparison of the prompt entered in input component 623 and the reply, etc.

In FIG. 6E, the observed user enters a new prompt into option 633. Here, the prompt string reads: “Provide a list of the areas in which artificial intelligence is impacting patent prosecution.” The user may enter the new prompt subsequent to the application surfacing the reply in response component 629 and/or subsequent to the application surfacing option 631. The user submits the prompt to a foundation model (not shown) via component 635, which causes the application to send the new prompt to the foundation model. The foundation model returns a reply responsive to the new prompt, and the application surfaces the reply as response component 637. The new prompt elicits a slightly different response from the foundation model, which is represented by response component 637.

In FIG. 6F, the observed user has returned to prompt assignment view 610. Here, the observed user can click on button 650 to turn in the assignment. Doing so causes the assignment to be turned in to the platform for the reviewer to review and grade.

FIGS. 7A-7D illustrate the experience of a reviewer when creating and assigning a prompt assignment in a user interface of an online learning platform. FIG. 7A illustrates user interface 700, which is representative of a user interface rendered by a collaboration application.

User interface 700 includes an application frame 701 across the top of the user interface that includes various features such as search box 702 for searching for contacts, files, chats, and the like in the collaboration application. Application frame 701 also includes controls for minimizing, maximizing, or closing the application. Along the left side of user interface 700, a feature bar 703 includes icons for launching various modules of the application. For example, feature bar 703 includes icons for alerts, messaging, team management, a calendar module, files, an assignments module, and an app store module. Each of the modules may be native to the collaboration application or separate add-in applications with respect to the collaboration application. In this example, the user has navigated to an assignments module for Prompt Drafting via icon 706. Selecting application icon 706 causes the assignments module to launch in the context of user interface 700, while maintaining the features and functionality of the collaboration application.

For example, panel 705 is a base panel for the Prompt Drafting team that the collaboration application displays in user interface 700. The Prompt Drafting team is representative of teams that may be created and managed with the collaboration application. As such, panel 705 provides the user with basic information about the team and various features available through the team, whereas feature panel 707 in the upper right portion of user interface 700 provides specific features of the assignments module. For example, panel 707 includes a conversations feature, a files feature, a class notebook feature, an assignments feature, and a search coach feature. It is assumed for exemplary purposes that the assignments feature has been selected, which results in the display of assignments creation view 710 in user interface 700.

Assignments creation view 710 is representative of a view produced in the user interface by the assignments module that allows reviewers to create new assignments. Assignments creation view 710 includes a title box 711 for naming a new assignment, a type box 713 for specifying the type of assignment (in this case, homework), and an instructions box 715 for inputting directions for completing the assignment.

Assignments creation view 710 also includes a resources element 717 selectable to make other tools available in the context of the assignment, a points box 719 for inputting the number of points allocated to the assignment, and rubric box 721 for specifying a rubric for the assignment such as criteria for assessing the assignment and gradients for evaluating the criteria. Assignments creation view 710 further includes a distribution box 723 for specifying to whom the assignment should be assigned, a deadline box 725 for specifying a due date, and time box 727 for the time of day the assignment is due. Finally, assignments creation view 710 includes a cancel button 728 for backing out of the assignment creation view, as well as an assign button 729 for posting the assignment to the class.

Here, it is assumed for exemplary purposes that the reviewer elects to select resources element 717 in order to add a tool to the assignment. As illustrated in FIG. 7B, the application responds to the user input by surfacing menu 730 in user interface 700. Menu 730 includes a list of available tools to link or otherwise attach to the prompt assignment including a notebook tool, a prompt coach tool, and a reading progress tool. It is further assumed for exemplary purposes that the user selects the prompt coach tool.

Referring to FIG. 7C, the application responds to the user's selection of the prompt coach tool in menu 730 by surfacing a prompt coach view 740 in user interface 700. Prompt coach view 740 includes a settings page 741 that allows the user to configure the prompt coach tool for the prompt assignment. For example, settings page 741 includes a submissions box 743 for specifying a minimum number of prompts required to be submitted for an assignment, an annotation box 745 for specifying a type of annotation required of an observed user (if any) when submitting a prompt, and a filter box 747 for specifying filters the application should include with an observed user's prompts (e.g., an age restriction appended to a user's prompt, etc.). The choices made in settings page 741 adhere to the new prompt assignment being created when the user selects the next button 749 to transition to a next stage in the creation process.

In FIG. 7D, user interface 700 has returned to assignments creation view 710. A prompt coach control 731 has been added to the view in response to the user adding the prompt coach tool to the assignment. In a next step, the user concludes that the assignment is ready to be posted and selects assign button 729. In the illustrated example, selecting the assign button 729 causes the new prompt assignment to be posted to an assignments page of the Prompt Drafting teams page for the observed users to view and complete.

FIG. 8 illustrates computing device 801 that is representative of any system or collection of systems in which the various processes, programs, services, and scenarios disclosed herein may be implemented. Examples of computing device 801 include, but are not limited to, desktop and laptop computers, tablet computers, mobile computers, mobile phones, and wearable devices. Examples may also include server computers, web servers, cloud computing platforms, and data center equipment, as well as any other type of physical or virtual server machine, container, and any variation or combination thereof.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803. Software 805 includes and implements prompt assignment process 806, which is representative of prompt assignment processes discussed with respect to the preceding Figures, such as prompt assignment process 200. When executed by processing system 802, software 805 directs processing system 802 to operate as described herein for at least the various processes, operational scenarios, and sequences discussed in the foregoing implementations. Computing device 801 may optionally include additional devices, features, or functionality not discussed for purposes of brevity.

Referring still to FIG. 8, processing system 802 may comprise a microprocessor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller capable of communicating with processing system 802 or possibly other systems.

Software 805 (including prompt assignment process 806) may be implemented in program instructions and among other functions may, when executed by processing system 802, direct processing system 802 to operate as described with respect to the various operational scenarios, sequences, and processes illustrated herein. For example, software 805 may include program instructions for implementing a prompt assignment process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to support insights features, functionality, and user experiences. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

It may be appreciated that, while the inventive concepts disclosed herein are discussed in the context of insights applications and services, they apply as well to other contexts such as productivity applications and services, gaming applications and services, virtual and augmented reality applications and services, business applications and services, and other types of software applications, services, and environments.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing device comprising:
one or more computer readable storage media;
one or more processors operatively coupled with the one or more computer readable storage media; and
an application comprising program instructions stored on the one or more computer readable storage media that, when executed by the one or more processors, direct the computing device to at least:
display a view of a prompt assignment in a user interface to a learning platform;
receive user input in a context of the prompt assignment, wherein the user input comprises a prompt associated with the prompt assignment;
submit the prompt to a foundation model, wherein the prompt elicits a reply from the foundation model; and
display the reply in the context of the prompt assignment.

2. The computing device of claim 1 wherein the prompt comprises a revision applied to an original prompt, wherein the revision is responsive to an option surfaced in the user interface that suggests the revision.

3. The computing device of claim 1 wherein, in response to a selection of a control in the user interface, the program instructions direct the computing device to transition the user interface from a classroom mode to a prompt assignment mode.

4. The computing device of claim 3 wherein the classroom mode includes the view of the prompt assignment, and wherein the view of the prompt assignment includes details of the prompt assignment and the control selectable for entering into the prompt assignment mode.

5. The computing device of claim 4 wherein the prompt assignment mode comprises a prompt assignment view, wherein the prompt assignment view includes an indication of the prompt assignment and components of a prompt assignment tool, wherein the components include a user interface to the foundation model via which the user supplies the user input and components for constructing the user input.

6. The computing device of claim 1 wherein, in response to a selection of a control in the user interface, the program instructions direct the computing device to transition the user interface to a reviewer mode of the prompt assignment.

7. The computing device of claim 6 wherein the program instructions direct the computing device to, while in the reviewer mode, display, in the user interface, a list of prompts previously submitted to the foundation model, wherein the list of prompts includes the prompt.

8. The computing device of claim 7 wherein the program instructions direct the computing device to, while in the reviewer mode:
evaluate the list of prompts to identify a progression of the list of prompts; and
identify, based on the progression, an understanding of the prompt assignment.

9. The computing device of claim 8 wherein the program instructions direct the computing device to, while in the reviewer mode, evaluate the conciseness of the prompt.

10. The computing device of claim 9 wherein the reviewer mode comprises a filter option selectable to apply a filter that limits a scope of replies from the foundation model that are eligible for display in the user interface, wherein the filter comprises:
an age filter that limits the scope of the replies to an age range;
a content filter that limits the scope of the replies to a range of content; and
a reviewer constraint that is specified by a reviewer of the prompt assignment.

11. A method of operating a learning platform hosted on one or more server computers, the method comprising:
on the one or more server computers:
providing, by the learning platform, a prompt assignment to a client device;
receiving, by the learning ser platform vice, a first prompt from the client device based on the prompt assignment;
transmitting, by the learning platform, the first prompt to a foundation model, wherein the first prompt causes the foundation model to generate a first reply based on the first prompt;
responsive to transmitting the first prompt to the foundation model, receiving, by the learning platform, the first reply from the foundation model; and
providing, by the learning platform, the first reply from the foundation model to the client device.

12. The method of claim 11, the method further comprising, on the one or more server computers:
generating, by the learning platform, one or more options based on the first prompt and the first reply generated by the foundation model, wherein the one or more options comprise recommendations to amend the first prompt based on the first reply;
providing, by the learning platform, a display of the one or more options to the client device;
receiving, by the learning platform, a selection from the client device of a first option the one or more options from the client device;
generating, by the learning platform, a revision prompt based on the selection of the first option; and
transmitting, by the learning platform, the revision prompt to the foundation model for a revised reply.

13. The method of claim 12, the method further comprising, on the one or more computer servers:
determining, by the learning platform, a reviewer mode for the prompt assignment;
generating, by the learning platform, a list of prompts submitted to the foundation model from the client device, wherein the list of prompts comprises the first prompt and the revision prompt; and
providing, by the learning platform, a display of the list of prompts submitted to the foundation model from the client device, wherein the list of prompts comprises the first prompt and the revision prompt.

14. The method of claim 13, the method further comprising, on the one or more computer servers, determining, by the learning platform, a progression within the list of prompts, and generating, by the learning platform, an indication of understanding of the prompt assignment for the client device based on the progression within the list of prompts.

15. The method of claim 14, wherein generating, by the learning platform, the indication of understanding of the prompt assignment for the client device comprises:
generating, by the learning platform, one of:
a textual summary of the progression within the list of prompts; or
a numerical summary of the progression within the list of prompts.

16. The method of claim 11, the method further comprising, on the one or more computer servers:
determining, by the learning platform, a filter option for replies generated by the foundation model; and
limiting, by the learning platform, the scope of replies generated by the foundation model that are provided to the client device.

17. The method of claim 16, wherein the filter option comprises one or more of:
an age filter that limits the scope of replies generated by the foundation model to an age range; a content filter that limits the scope of replies generated by the foundation model to a range of content; or a reviewer constraint that is specified by a reviewer of the prompt assignment.

18. The method of claim 11, the method further comprising, on the one or more computer servers:
determining, by the learning platform, a first category of the first prompt;
generating, by the learning platform, first suggestion for the first prompt based on the first category;
receiving, by the learning platform, a revision prompt based on the first suggestion;
determining, by the learning platform, a second category of the revision prompt; and
generating, by the learning platform, a second suggestion for the revision prompt based on the second category.

19. The method of claim 11, the method further comprising, on the one or more computer servers:
analyzing, by the learning platform, the first prompt and the first reply based the prompt assignment;
determining, by the learning platform, an improvement for the first prompt based on the prompt assignment;
generating, by the learning platform, a suggestion of the improvement for the first prompt based on the prompt assignment; and
providing, by the learning platform, the suggestion of the improvement for the first prompt based on the prompt assignment.

20. One or more computer readable storage media having processor-executable instructions stored thereon configured to cause one or more processors to:
provide, by a learning platform, a prompt assignment to a client device;
receive, by the learning platform, a first prompt from the client device based on the prompt assignment;
transmit, by the learning platform, the first prompt to a foundation model, wherein the first prompt causes the foundation model to generate a first reply based on the first prompt;
responsive to transmitting the first prompt to the foundation model, receive, by the learning platform, the first reply from the foundation model; and
provide, by the learning platform, the first reply from the foundation model to the client device.
